(19) United States
(12) Patent Application Publication
(10) Pub. No.: US 2007/0043594 A1
(43) Pub. Date: Feb. 22, 2007

(54) National healthcare information/transaction network for interoperability: standardizing delivery of healthcare through biometric smart cards & biometric smart chip-based devices

(76) Inventor: Ken Jerome Lavergne, Atlanta, GA (US)

Correspondence Address: Ken Lavergne;Ste 1707, 700 Park Regency PL, Atlanta, GA, 30326, US

(21) Appl. No.: 11/391,062

(22) Filed: Mar. 28, 2006

Related U.S. Application Data
(60) Provisional application No. 60/708,575, filed on Aug. 17, 2005.

(51) Int. Cl. G06Q 10/00; H04L 9/32; G06Q 99/00

(52) U.S. Cl. 705/2; 726/9; 705/64

(57) ABSTRACT

Novel systems, methods and apparatus are disclosed for enabling the standardization of healthcare delivery which provides a simple, convenient and paperless experience for the patient. In an embodiment, ubiquitous standardization of communication nationwide and internationally at point-of-care is initiated and implemented via patient mobile device. The integration of mobile device biometrics improves the privacy and security of patients and the incorporation of NFC technology effectuates the simple transfer of information—from patient data to electronic transactions—allowing the patient and healthcare industry to instinctively interact with their healthcare electronic environment. The present invention produces more accurate, appropriate and reduced redundancy in the healthcare delivery system and integrates a mechanism for enabling market place interaction of the consumer-driven healthcare movement—putting more control/access into the patient's hands. This instant invention bridges today's connectivity gap in the healthcare arena and as such, revolutionizes the payment, bank and healthcare industries.

### CROSS REFERENCE TO RELATED APPLICATIONS

This application claims the benefit of Provisional Patent Application No. 60/708,575, filed Aug. 17, 2005.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### NOTICE OF COPYRIGHT PROTECTION

This patent document and its figures comprise material subject to copyright protection relative to a portion of its disclosure. There is no objection by the copyright owner to the facsimile reproduction by anyone of the patent document or the patent disclosure, but the copyright owner otherwise reserves all copyrights whatsoever.

### BACKGROUND OF THE INVENTION

Computer networks and smart cards have been a part of healthcare in hospitals and physician offices for some time. Recently there has been network-based software introduced to create a telecommunication healthcare information system with mobile devices, including mobile phones, PDAs and the like. Further, technologies have been proposed for which biosensor networks adapt smart card systems for sharing information relative to the health of a user, such as cholesterol, thyroid hormone, clotting time & blood pressure monitoring. In addition, it has been proposed to use a smart card system which provides payment options for patient co-pay, patient insurance benefit information and third party co-pay. Finally, it has been proposed to create a network connection that uses biometric mobile devices and electronic devices that can store or transmit data relevant to a patient through intuitive connectivity of Near Field Communication (NFC) technology also known as peer-to-peer communication protocol.

Communication exchange between mobile devices and electronic equipment that does not need to set up communication manually, opens myriad opportunities for data and high-quality image transfer as well as management of personal data stored within different types of electronic devices at healthcare-related facilities—pharmacies, labs, Medicaid/Medicare, etc.

Research on prior art listed below, incorporated herein by reference, either require use of software or smart card for effectuating data exchange or does not use peer-to-peer communication protocol:

US2004/0059598A1 Network-Based Healthcare Information Systems—Wellons, David L. et al

US2005/0101841A9 Healthcare Networks with Biosensors—Kaylor, Rosann et al

US2003/0236747A1 Payment Convergence System and Method—Sager, Robert David

U.S. Pat. No. 6,012,035 System and Method for Supporting Delivery of Healthcare—Freeman Jr., Berkley et al

US2004/0128268A1 Best American Healthcare System—Benja-Athon, Anuthep

US2004/0215560A1 Integrated Payment System and Method—Amalraj, Peter et al

US2005/0137977 Method and System for Biometrically Enabling a Proximity Payment Device—Wankmueller, John

US2005/0288972A1 Direct Connectivity System for Healthcare Administrative Transactions—Marvin, William F. et al

U.S. Pat. No. 6,972,662B1 RFID (Radio Frequency Identification) and IC Card—Ohkawa, Takehiro et al

U.S. Pat. No. 6,848,617B1 Smart Card Module for Biometric Sensors—Fries, Manfred et al

U.S. Pat. No. 6,961,942B1 Bluetooth TDI & Winsock Interface—Adermann, Stanley W. et al

US2001/0010689A1 Interoperability for Bluetooth/IEEE 802.11—Awater, Geert Arnout et al

US2003/0028484A1 Method and Devices for Inter-Terminal Payments—Boylan, Cornelius et al

US2002/0010594A1 Method of Payment for A Healthcare Service—Levine, Michael R.

US2005/0190269A1 Transferring Data Between Devices—Grignani, Raphael

US2004/0242216A1 Systems and Methods for Transferring Data Between Mobile Stations—Boutsikakis, Demetrios

US2002/0060243A1 Biometric Authencation Device for Use in Mobile Telecommunications—Janiak, Martin J. et al

US2002/0095587A1 Smart Card with Integrated Biometric Sensor—Doyle, Ronald R. et al

US2004/0015704A1 Smart Chip Biometric Device—Schrijver, Stefaan

WO2004/044828A1 System and Method for Mobile Biometric Authentication—Vollkommer, Richard M. et al

EP1335513A1 Method for Transferring Encrypted Information—Rebhan, Richard et al

U.S. Pat. No. 6,366,893B2 System, A Method And An Apparatus for Performing an Electric Payment Transaction in A Telecommunication Network—Hannula, Antti et al

U.S. Pat. No. 6,934,689B1 Payment Transaction Method And Payment Transaction System—Ritter, Rudolf et al

US2005/0238149A1 Cellular Phone-Based Automatic Payment System—DeLeon, Hilary

### OBJECTS OF THE INVENTION

A principal object of the present invention is to provide patients standardized systems, methods and apparatus for wireless healthcare delivery to create interoperability and intuitive connectivity across markets, the nation and internationally while also providing the healthcare industry as well as patients with a completely automated and transparent manner of electronic communication between various devices to effectuate a simple, convenient and paperless experience for the patient.

Another object of the present invention is to provide a secure system that exchanges multiple types of information about patients including but not limited to patient insurance benefit information, Electronic Medical Records (EMRs), imaging scans (MRIs, etc.), payment options for patient co-pay, third party co-pay information and drug therapy information.

Another object of the present invention is to bridge today's healthcare connectivity gap through a protocol based on a wireless interface using a ubiquitous open infrastructure of peer-to-peer communication network which provides communication set-up in conjunction with other long-range wireless protocols like Bluetooth or Wireless Ethernet (Wi-Fi), etc.

Another object of the instant invention is to provide two (2) layers of privacy and security for network users incorporating the following:

(1) inherently secure communication exchange

(2) mobile biometric authentication

Yet another object of the instant invention is to provide a system that not only uses peer-to-peer network devices but also enables these network devices to work with contactless smart cards and contactless smart card readers in a seamless manner. The compatibility of these protocols (as developed by Philips and Sony) is described at htt://www.sony.com (dated Sep. 5, 2002), incorporated herein by reference.

### SUMMARY OF THE INVENTION

Although many parties have proposed healthcare systems which involve data transmission from electronic devices to healthcare providers to standardize patient care, these types of systems have not been integrated with the healthcare system in a way that focuses on a simple, convenient and paperless experience while providing instinctive privacy and security protection for the patient. Individual privacy is paramount for patients that use electronic devices to transmit data via electronic means (wired or wireless). Interception and misrouting of data create fears that confidential patient information will be made known by others such as an insurer or employer. Other privacy needs involve the sensitive nature of patient information transmission to various healthcare entities. What is needed is a network connection which is inherently secure due to the ultra-short range of distance needed between devices in order to communicate to insure patient's privacy and maintaining sense of control over information. And, as well, creating another level of security through mobile biometric authentication is needed.

Further, it is important that patients and healthcare providers not have to face the complexities of setting up network connections between devices. Current network-based systems and smart card implementation either require a software download and/or a disruption of workflow in the day-to-day delivery of healthcare which drains precious time away from patient care. Therefore, in addition to an inherently secure network what is needed is a system which allows users to instinctively interact with their healthcare electronic environment without needing to navigate complicated menus or perform complex set-up procedures.

This present invention relates to a ubiquitous open infrastructure of NFC technology implementing healthcare systems and methods focused on the patient and healthcare user. The patient and healthcare user will be able to use an inherently secure means of communication between various biometric, NFC-compliant devices at the point-of-care. This communication occurs without exerting much intellectual effort or causing workflow disruption in configuring the devices' network to exchange information electronically as needed within and to various destinations. This present invention further relates to a biometric sensor integration in a smart card microcontroller for improved privacy and security.

Healthcare delivery systems require standardization and interoperability implemented by intuitive connectivity. Contactless smart cards require presenting the card to a Reader. This invention being described uses an NFC-compliant device for achieving a fully automatic and transparent establishment of the network connection without the need for patient or healthcare provider intervention and an expensive infrastructure. It can easily be deployed because mobile devices, including PDAs, PCs, mobile phones and the like are now the most commonly found consumer electronic devices today, with hundreds of millions of users the world over. It can be used in all aspects of healthcare including, but not limited to, point-ofcare at doctor's office, hospital, pharmacies, labs, clinics and the like which require transfer of content and communication set-up for longer range protocols.

This present invention operates through the use of an electronic wireless interface protocol which establishes wireless network connections between consumer electronic devices and network appliances by simply bringing said two devices together or making them touch as disclosed at http://www.philips.com, incorporated herein by reference.

The protocol solution for this easy communication network evolved out of a new near field radio frequency communication technology which was jointly developed by Royal Philips Electronics and Sony Corporation. A press release on Sony's website dated Sep. 5, 2002 which is titled “Philips and Sony Announce Strategic Cooperation to Define Next Generation Near Field Radio Frequency Communications,” provides a review of the technology at http://www.sony.net/SonyInfo/News/Press/200209/02-0905E/, incorporated herein by reference.

At the point of care, a patient presents their NFC-enabled mobile device and touches it to the NFC-enabled desktop at the doctor's office. After the patient's identity has been authenticated via mobile biometrics, the automatic network connection links to the patient's insurance company to check what the patient is eligible for and what the deductible and co-pay are. Once the patient has received medical treatment, the patient presents their mobile device and touches the desktop once more at which time the insurance company recognizes the claim and authorizes payment electronically—no paper, no printing needed.

This invention being described combines automated and transparent electronic communication via NFC technology and the convenience of mobile devices such as mobile phones, PDAs, PCs and the like. It capitalizes on the fact that patients and healthcare providers are increasingly looking for a fast, simple and convenient way through technology to access healthcare data and services wirelessly without the hassle of configuring network connections.

Setting up a Wi-Fi (Wireless Ethernet) network or Bluetooth link is a process which involves a number of steps. First, which electronic devices are in wireless range needs to be established. Secondly, each device needs to be authenticated. And finally, in order to establish the connection a few passwords probably need to be typed-in. Essentially, all that occurs is the exchange of set-up information. The complexity in using long-range protocols like Wi-Fi or Bluetooth is in selecting the correct device out of multiple devices in the range and providing the right parameters to the connection. This is where NFC technology brings value. With an NFC-enabled Wi-Fi or Bluetooth device, all that is needed to establish connections between them is to bring them within a few centimeters of each other. The devices will automatically detect the presence of the other via their respective NFC controllers, exchange the necessary link set-up data and ask the user to confirm the connection (or if user desires, do it automatically) and the Wi-Fi or Bluetooth connection will be made. Not only does this peer-to-peer communication protocol set-up communication links (connectivity) which is completed in 100-200 milliseconds, it also enables other applications such as data exchange, transfer of high quality images, RFID and payment The above described communication link process and the protocol description is available now at http://www.philips.com, incorporated herein by reference.

Every doctor or hospital visit by the patient produces an electronically updated Electronic Medical Record (EMR) which is simultaneously transferred to the patient's mobile device upon check-out when their device is presented to the desktop after treatment. This real-time communication of a person's medical history can be critical, particularly in emergencies.

This invention being described effectuates the system, method and apparatus for a “National Healthcare Information/Transaction Network for Interoperability: Standardizing Delivery of Healthcare through Biometric Smart Cards & Biometric Smart Chip-Based Devices.” For instance, let's say a patient traveling from Atlanta (Home) to Seattle suddenly becomes ill once in Seattle and needs to see a physician. At the doctor's office, the patient simply presents their mobile device, touches the doctor's desktop after being authenticated and their medical history is transferred to the new physician. With this kind of electronic standardized, intuitive connectivity and interoperability, more complete information will produce more appropriate and reduced redundant care as well as prevent medical errors.

The foregoing and other objects are intended to be illustrative of the invention and should not be construed as limitations on the scope of the invention. Many possible embodiments of the invention may be and will be readily evident upon a study of the following specificities and accompanying drawings comprising a part thereof. Many different features and sub-combinations of invention may be employed without reference to other features and sub-combinations. The construction and method of operation of the invention along with additional objects and advantages thereof will be best understood from the proceeding description of specific embodiments when read in connection with the accompanying drawings and, as such, possibilities exist for modifications and structural changes which may be made therein without departing from the spirit of the invention and within the scope and range of equivalents of the claims.

### BRIEF DESCRIPTION OF DRAWINGS

Preferred embodiments of the present invention, illustrative of the best approach in which the applicant has contrived applying the principles, are presented in the proceeding description and are shown in the drawings. The preferred embodiments are particularly and distinctly pointed out and presented in the appended claims.

FIG. 1 depicts mobile biometric authentication

FIG. 2 illustrates communication between two NFC-enabled devices, a mobile phone and a desktop modem.

FIG. 3 is a flowchart of one possible embodiment of a healthcare provider visit by a patient

FIG. 4 illustrates communication between an NFC-enabled mobile phone and the Processor.

FIG. 5 is a diagram showing NFC-enabled mobile phone data retrieval from smart card.

FIG. 6 shows communication between various NFC-enabled electronic devices.

FIG. 7 depicts the international magnitude of interoperability and intuitive connectivity of the present invention.

FIG. 8 shows end user biometric processing (registration) with procured NFC-enabled device.

FIG. 9 illustrates the security components of biometric information processing integrated with the smart card microcontroller

### DETAILED DESCRIPTION OF THE INVENTION

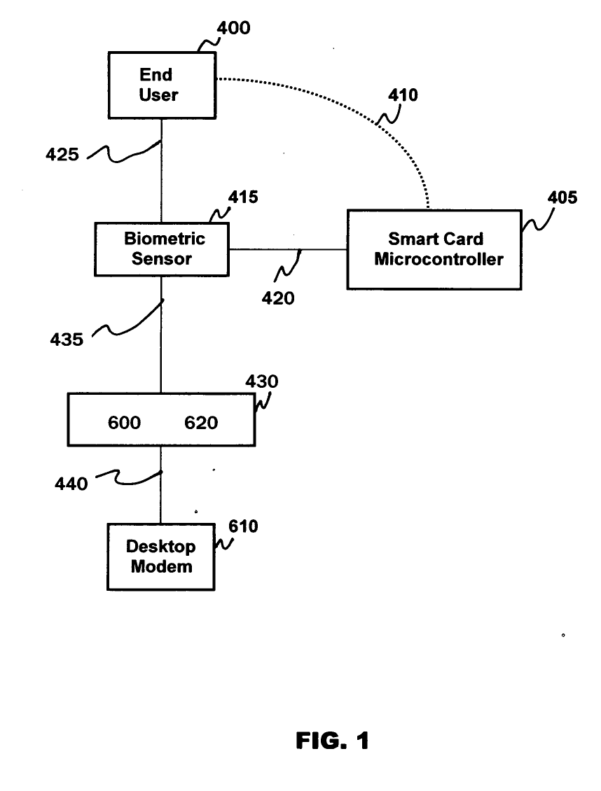

In a preferred embodiment of healthcare delivery, FIG. 1 depicts a schematic representation of a biometric system in accordance with the present invention. In the system, end user 400 is either a patient who wishes to initiate point-of-care or a doctor who wishes to access and update an EMR, e-prescribe, etc. relative to administering patient treatment. Patient or doctor, hereinafter both referred to as end user 400, is first required to submit to an authentication process to verify his or her identity. Smart card microcontroller 405 represents stored biometric information of end user 400 and therefore there is a biometric link 410 between smart card microcontroller 405 and end user 400. For this authentication, end user 400 may be instructed to swipe his or her index fingerprint sample 425 on mobile phone 600 or PDA 620 scanner, not pictured, to be read by biometric sensor 415. In response, biometric sensor 415 extracts and encrypts fingerprint sample 425 using the methods deployed for fingerprint analysis and data encryption. Biometric sensor 415 may next or concurrently establish a secure wireless communication channel to smart card microcontroller 405 via connection 420 over which encrypted fingerprint sample 425 is transmitted to the smart card controller chip in smart card microcontroller 405. Smart card microcontroller 405 decrypts the received fingerprint sample 425 and electronically compares the decrypted fingerprint sample 425 with the stored sample stored in its memory. Biometric sensor 415 works with NFC-enabled electronic device 430 (mobile phone 600, PDA 620) via connection 435 to initiate point-of-care as well as EMR access and update, e-prescribing, etc. according to the results of this comparison. Smart card microcontroller 405 may confirm that the patient or doctor is processed end user 400 or may determine that end user 400 is an unauthorized patient or doctor. Accordingly, electronic device 430 may be self-validated or invalidated for use at point-of-care or healthcare delivery. A self-validation of electronic device 430 allows point-of-care initiation and/or EMR access, EMR update and/or e-prescribe, etc. via wireless connection 440 to doctor's desktop modem 610.

Controller chip technology is disclosed in U.S. Pat. No. 5,847,372, “Chip Card,” issued Dec. 8, 1998 to Kreft, Hans-Diedrich, incorporated herein by reference. As adapted for the present invention, two microcontroller chips—an NFC controller chip and a smart card controller chip are employed.

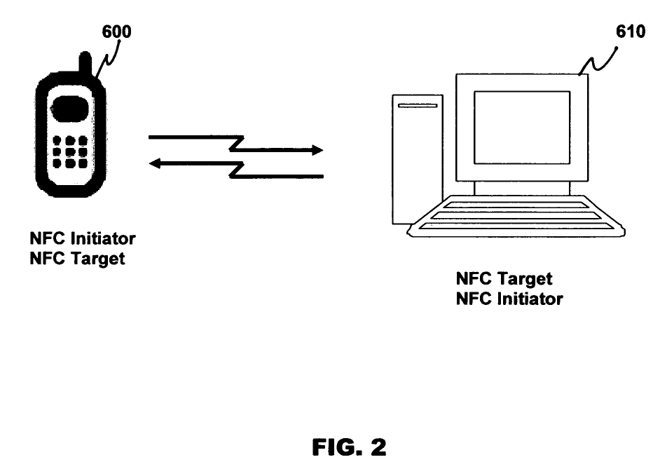

FIG. 2 shows an NFC-compliant mobile phone 600 communication with an NFC-compliant desktop modem 610 at the point-of-care. In the illustrated embodiment, the NFC controller chip is embedded inside the mobile phone. The smart card controller chip, which is an additional chip to the NFC chip, contains multiple applications/layers of information. Communication between NFC-compliant devices and the S2C interface between the NFC chip and smart card controller chip is illustrated and described, respectively, at http://www.philips.com, incorporated herein by reference. (S2C interface is the intellectual property of Philips.) The smart chip carries four applications/layers of information: A) Patient Information, B) Patient Insurance Benefit Information, C) Third Party Payment Information and D) Patient Payment Information disclosed in US2003/0236747A1, “Payment Convergence System and Method,” issued Dec. 25, 2003 to Sager, Robert David, incorporated herein by reference.

Patient information includes name, address, phone, social security number and so forth.

Insurance benefit information includes insurance policy identification information (account number), plan information, subscriber/patient information, secondary coverage information (i.e. partial coverage from a spouses' insurance policy, etc.), amount of policy limits and co-pay caps utilized, co-pay percentages, eligibility information, policy limits and any pertinent insurance coverage information.

Third party payment information is inclusive of any insurance coverage that is secondary to the primary insurance policy, in addition to any private credit (line of credit) accounts for healthcare, government assistance, social security, cafeteria plans, gift certificates, pre-payments, charitable gifts, loyalty credit (i.e. earned credit for customer loyalty, analogous to frequent flyer program) or any other source that is not the primary insurance entity and not a payment directly from the patient.

Patient payment information encompasses any payment the patient funds directly, such as the patient's debit or credit card, check, EBT or any other patient-controlled account.

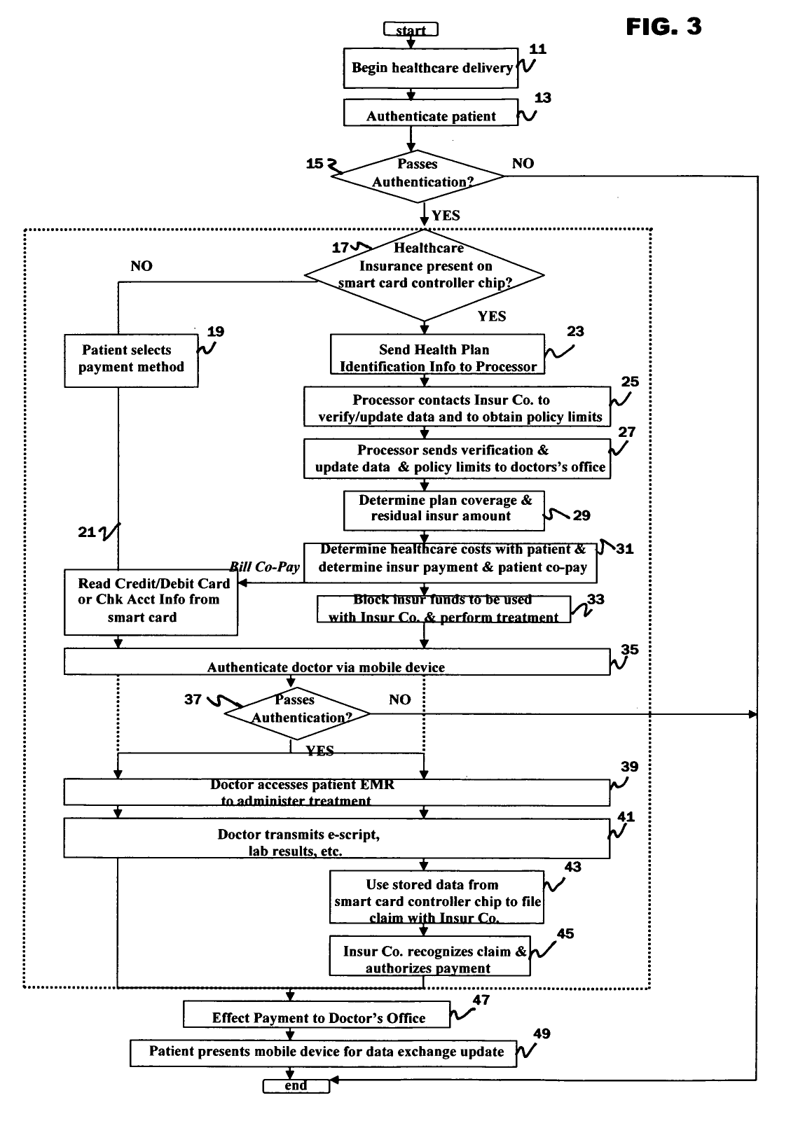

The flowchart of FIG. 3 shows one possible embodiment of the instant invention as it is implemented at a doctor's office utilizing two layers. Layer B, patient insurance benefit information and layer D, patient payment information as disclosed in US2003/0236747A1, “Payment Convergence System and Method,” issued Dec. 25, 2003 to Sager, Robert David, incorporated herein by reference. As adapted for this invention, the smart card microcontroller is embedded inside the mobile phone.

As indicated at Blocks 11 and 13 of FIG. 3, the healthcare delivery system begins when the patient enters into the doctor's office and is authenticated. Block 15 checks to see if the patient was successfully authenticated. If not, then the processing of FIG. 3 preferably ends. Otherwise, processing continues to Block 17 in which the patient presents their personal NFC-enabled mobile phone 600 by touching it at the “hot spot” of the doctor's desktop 610 which is NFC-enabled and therefore capable of reading the smart card controller chip. This allows the doctor to verify the patient's insurance eligibility. The eligibility verification process is initiated once the respective “hot spots” of mobile phone 600 and desktop 610 are touched. This process involves the two said electronic devices first opening a connection to exchange parameters of the particular wireless protocol (Wi-Fi, Bluetooth, etc.) and establish a secret key to protect the communication. The wireless protocol communication is established after the exchange of set-up data without any intervention from the patient or doctor. If the smart card controller chip does not include health insurance information, a payment method selection will be made by the patient that does not include insurance in Block 19. If the smart card controller chip stores the appropriate payment information selected by the patient, that information will be accessed by the doctor's desktop 610 in Block 21.

If the smart card controller chip does contain the patient's insurance information, health plan identification information, such as an identification number will be included. In Block 23, the doctor's desktop 610 will send the patient's health plan identification information to the Processor. The patient's insurance company is contacted by Processor 700 in Block 25 to verify and update the data contained on the patient's smart card controller chip and to procure additional insurance information not stored on the smart card controller chip such as policy limits. Processor 700 will send the data procured from the insurance company back to the doctor's office in Block 27. Desktop 610 at the doctor's office will then determine whether the desired treatment is covered by the patient's health insurance in Block 29. If it is determined that the treatment is covered by the patient's insurance, the amount of coverage and the co-pay amount required to be paid by the patient will be determined in Block 31. This will be done by an automated system through desktop 610 terminal in the preferred embodiment. As an alternative, Block 31 can be accomplished manually by the doctor and patient or automatically by the smart card controller chip itself, if appropriate processing capability is available. Alternatively, the co-pay amount required by the patient can be determined by the insurance company which can transmit that amount to the doctor.

In Block 33, the doctor's office will procure authorization for the insurance funds amount to be used for the doctor visit. This ascertains policy limits are not exceeded before the visit is complete and that the amount of co-pay required by the patient does not change.

In Block 35, regardless of whether the smart card controller chip does or does not contain health insurance information, the doctor is authenticated. Block 37 checks to see if the doctor was successfully authenticated and if not, then the processing of FIG. 3 preferably ends. Otherwise, processing continues to Block 39 in which the doctor accesses the patient's EMR in order to administer treatment accordingly. The EMR is transmitted to his or her mobile device from desktop 610 by simply touching the “hot spots” of the two devices. The doctor then enters the exam room with patient's EMR displayed on his or her mobile device and treats. Upon exam completion, the doctor transmits any recommended e-script, lab tests, MRI, etc. from his or her mobile device to the patient's mobile phone 600 by simply touching the two devices at their respective “hot spot” in Block 41. The doctor updates the patient's EMR via his or her mobile device and then transmits the updated EMR to desktop 610.

For the patient with stored health insurance information on the smart card controller chip, in Block 43 the doctor will use the patient's information which was stored on mobile phone 600 smart card controller chip to file a claim with the insurance company. This claim is filed electronically through Processor 700 at which time the insurance company recognizes the claim and authorizes the payment in Block 45.

For the patient without stored health insurance information on the smart card controller chip, if the appropriate payment information selected by the patient is stored on the smart card controller chip, that information will be accessed by the doctor's desktop 610 in Block 21.

Regardless of stored or non-stored smart card controller chip health insurance information, co-pay and payment of either of the two smart card controller chip storage scenarios will be effectuated to the doctor in Block 47.

It should be noted that Processor 700 contacted to procure payment using patient's payment information (i.e. the patient's credit card in Block 47) may be a different Processor 700 than the one contacted to procure insurance information in step 23.

Upon check-out, Block 49 involves the patient touching their mobile phone 600 at the “hot spof” of desktop 610 to provide data exchange update of personal EMR to be stored on mobile phone 600 smart card controller chip and desktop 610 for the next visit at preferable healthcare/medical facility and the like. This electronic update can include any and all patient data, images (MRI), lab results, etc. This instant invention effectuates a paperless healthcare delivery experience using NFC-compliant mobile devices of the doctor and patient from reception station to exam room back to reception station.

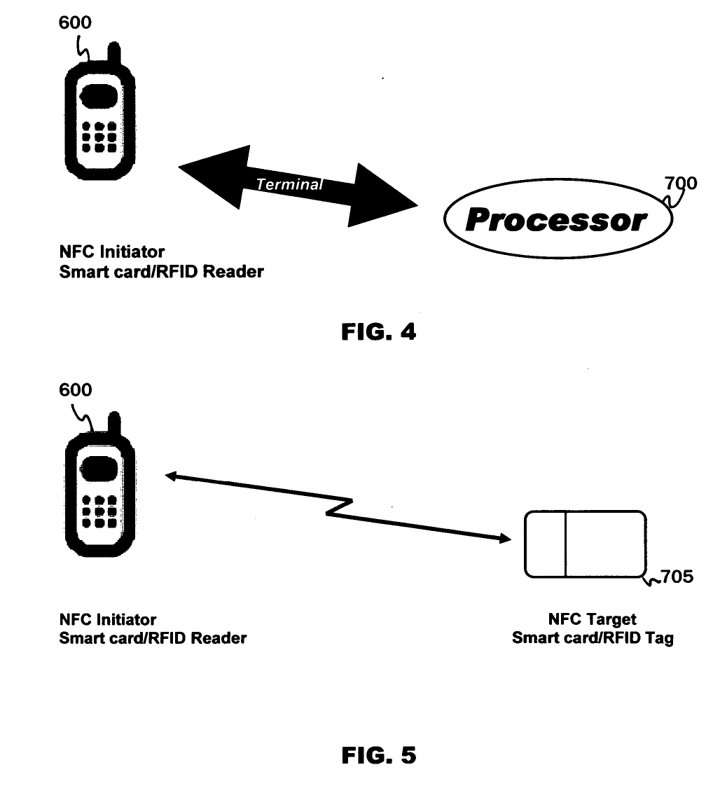

FIG. 4 shows an illustration of communication between the patient's personal mobile phone 600 and Processor 700 through the doctor's desktop 610 terminal which can either be an NFC-enabled desktop 610 terminal or if there is no NFC-enabled electronic device at the doctor's office, a point-of-sale (POS) terminal not pictured. The data from Processor 700 is sent to the above appropriate terminal which can be transferred to the patient's mobile phone upon communication commencement.

In the event there is not an NFC-enabled device at preferable healthcare. facility—doctor's office, hospital, lab, clinic, pharmacy and the like, the patient is able to use their smart card 705 issued by their insurance company at the aforementioned facilities. Once services at the preferable facility are rendered with the use of the patient's smart card 705 at point-of-care, the patient can use their mobile phone 600 to retrieve data from smart card 705 effectuated at the preferable facility as illustrated in FIG. 5. This passive mode of operation is described and illustrated now at http://www.philips.com, incorporated herein by reference.

The NFC technology provides unique privacy/security to the patient and healthcare provider. As the ultra-short range not only dictates that devices must be intentionally close together in order to communicate, it also makes the resulting information exchange inherently secure and therefore HIPPA compliant The communication is protected because with NFC's very limited range someone trying to eavesdrop would need to be so close that the patient or healthcare user would certainly notice.

This instant invention employs NFC technology standards described by the European Computer Manufacturers Association (ECMA) and the International Organization for Standardization (ISO) available now at http://www.ecma-international.org or http://www.iso.org, respectively, incorporated herein by reference. The European Telecommunications Standards Institute (ETSI) provides NFC standards as well, as described and available now at http://www.etsi.org, incorporated herein by reference. NFC technology evolved from a combination of contactless identification and interconnection technologies operating in the RFID 13.56 MHz frequency range, active over a distance of up to 20 cm. Standardization layers of NFC technology include ISO 18092, ISO 21481, ECMA (340 & 352) and ETSI TS 102 190. NFC is also compatible with contactless smart card 705 markets based on ISO 14443, Philips Mifare technology and Sony's FeliCa technology. The protocol communication speeds are from 106 kbps, 212 kbps, 424 kbps to 848 kbps.

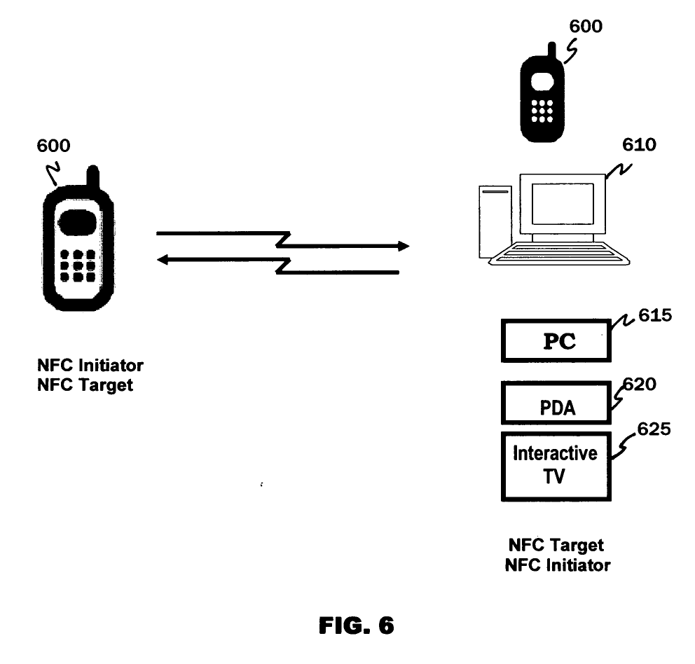

It is understood that a significant benefit of this instant invention is that current database and enterprise applications will become less and less adequate for the healthcare industry with this embodiment of system, methods and apparatus for the standardization of healthcare delivery. This benefit is quite evident as data is captured in real time and turned into actionable information quickly in this present invention. Further, the need to navigate complicated menus or perform complex set-up procedures is eliminated thus allowing the patient and healthcare provider to interact instinctively with their electronic healthcare environment of different entities through their respective NFC-compliant devices. Therefore, it is possible for any and all healthcare delivery to be effectuated by this instant invention between patient/consumer and health/medical-related institutions including, but not limited to, doctors, hospitals, health insurers, Medicare/Medicaid, pharmacies, labs, clinics and banks/financial institutions without departing from the spirit of the invention. FIG. 6 illustrates that in this present invention any electronic NFC-compliant device can be used to effectuate healthcare delivery including, but not limited to, mobile phone 600, desktop modem 610, PC 615, PDA 620, Interactive TV 625, etc. This active mode of operation is described and illustrated now at http://www.philips.com, incorporated herein by reference.

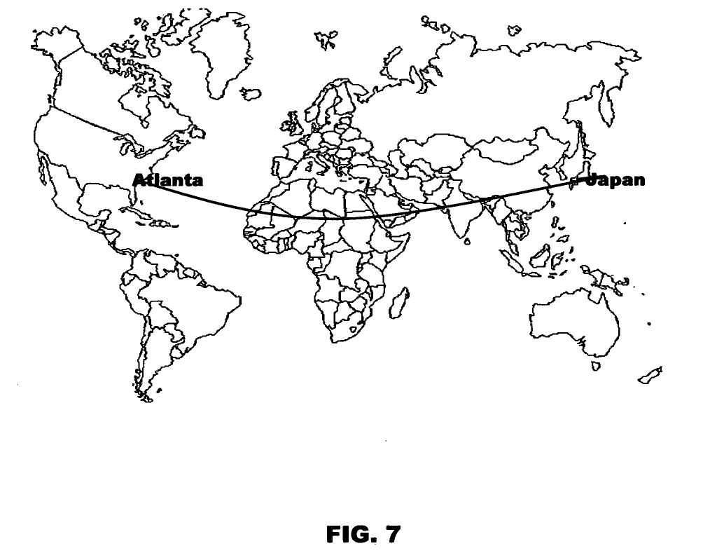

This present invention provides a healthcare connection worldwide as shown in FIG. 7. A person traveling from Atlanta to Japan who needs medical attention only needs to present their NFC-enabled mobile phone 600 at the point-of-care to initiate accurate, appropriate and timely treatment needed as the patient's EMR, medical insurance information, images and other pertinent information is stored on mobile phone 600. The world map represents the magnitude of interoperability and intuitive connectivity which is held in the palm of a patient's hand and effectuated through the novel systems, methods and apparatus disclosed in this present invention. The instant invention is like packing your luggage with all you need for traveling but without the hassle of preparing the suitcase. The patient's medical history is already stored and ready for use anytime, anywhere.

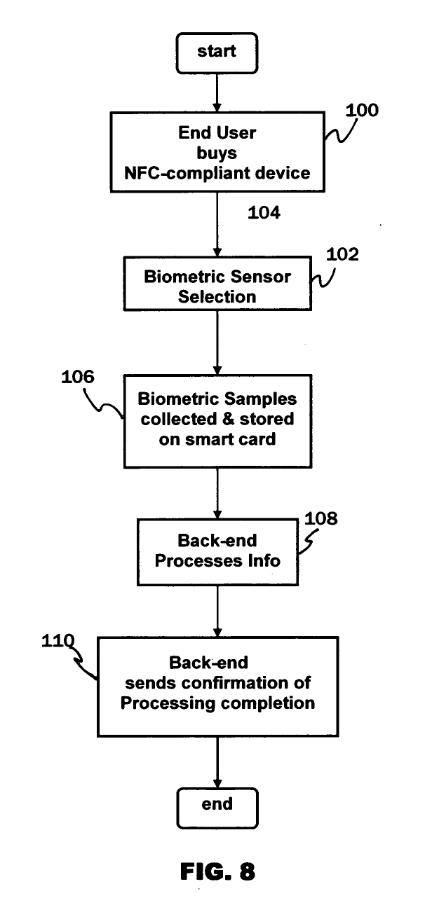

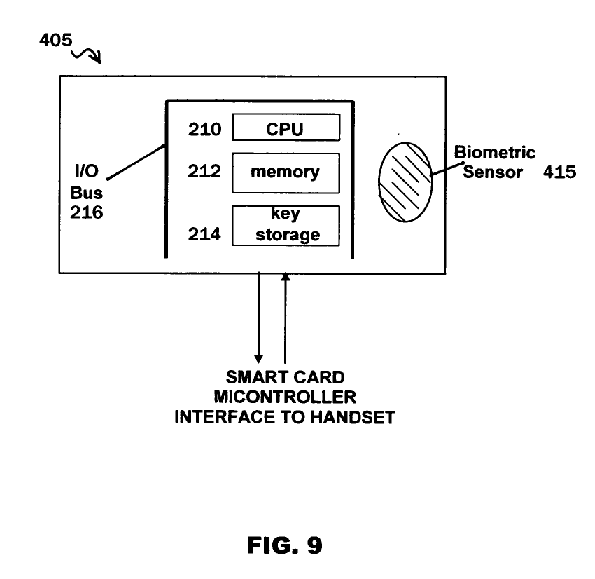

The instant invention integrates an additional privacy/security element to the patient and healthcare user which is also HIPPA compliant using mobile device biometrics. The biometric system can employ tools disclosed in US2002/0060243A1, “Biometric Authentication Device For Use In Mobile Telecommunications,” issued May 23, 2002 to Janiak et al., incorporated herein by reference. The disclosed fingerprint module of Janiak et al is useful in access and control, user identification and verification applications as well as time and attendance. As adapted for this present invention, biometrics is used for patient and doctor identification verification. FIG. 8 illustrates the procedure for procuring an NFC-enabled device and processing (registering) a patient or doctor, both hereinafter referred to as end user 100, in what is described as a biometrics anywhere initiative. To obtain an NFC-compliant device, end user 100 simply buys NFC-compliant device from a consumer electronics store. The said device can be a mobile phone, PDA, PC and the like. When end user 100 initiates processing in a biometric authentication program, he or she is presented with a list of biometric sensor choices 102 from which they select one choice. Such data is stored on the smart card controller chip which represents stored biometric information of end user 100 and therefore there is a biometric link 104 between the smart card controller chip and end user 100. Subsequently, end user 100 has biometric samples collected 106 from their person relative to their selected choice. The sample collection can take place at the preferable doctor's office or any healthcare delivery facility including, but not limited to, hospitals, clinics, labs, pharmacies, etc. Biometric sample collection 106 is done in a manner such that the layer can be compared to a live biometric sample of end user 100. End user's 100 sensor information is then received and processed at the back-end 108 after which the back-end sends confirmation of successful processing completion 110 and that the biometrics system can already be used for authentication. The aforementioned procedure is to ensure end user identity of authorized patient or doctor.

The smart card biometric sensor integration disclosed in US2002/0095587A1, “Smart Card with Integrated Biometric Sensor,” issued Jul. 18, 2002 to Doyle et al., is incorporated herein by reference. The disclosed biometric integration system of Doyle et al includes a smart card which contains a biometric sensor embedded on the card surface and a scanner apparatus embedded in the surface thereof. The smart card is responsible for validation of the biometric information. As adapted for the present invention, the biometric sensor and scanner apparatus can be a fingerprint sensor and fingerprint scanning apparatus embedded on the surface and embedded in the surface of the smart card microcontroller, respectively, and in which the previously-stored secrets include a fingerprint of the authorized end user.

In addition to a fingerprint sensor, the biometric sensor may be: a palm print sensor; a voice print sensor; a retina scanner; a skin chemistry sensor or any other type of sensor. In addition to a fingerprint scanning apparatus, the biometric scanner may include, but is not limited to, a palm print, a voice print, retinal and skin chemistry sensors. For each of the aforementioned sensors the respective previously-stored secrets include a palm print, a voice print, a retina scan or skin chemistry of the authorized end user.

Stored biometric information of the authorized end user are included in the preferably previously-stored secrets and the smart card controller chip preferably includes means for biometric information comparison. The procurement of the said biometric information occurs via the biometric sensor from an end user, and is then compared to the stored biometric information of the authorized patient. Means for accessing selected ones of the previously-stored secrets may also be comprised by the smart card controller chip only if it is determined by the means for comparing that the procured biometric information of the user matches the stored biometric information of the authorized end user. As such, the use of encryption is the preferred approach for computing digital signatures for embodiments of the present invention. Alternatively, without deviating from the inventive spirit thereof, a private cryptographic key may be included in the previously-stored secrets and the means for accessing preferably further consists of means for accessing the private key to compute a digital signature over information presented to the smart card controller chip.

FIG. 9 illustrates the security components of biometric information processing integrated with smart card microcontroller 405: the end user provides their biometric input through biometric sensor 415 and smart card microcontroller 405 procurement of this information occurs through accessing the biometric sensor 415 across the I/O bus 216 of smart card microcontroller 405. The secure transfer of information is enabled by the I/O bus 216 among the biometric sensor 415, on board CPU 210, memory 212 and key storage 214. Smart card microcontroller 405 with its protected information is effectively the security core. In the preferred embodiment, the only access means of the input data from biometric sensor 415 is via I/O bus 216. Integrating biometric sensor 415 with smart card microcontroller 405 obviates the need to transmit user authentication credentials such as a PIN from an input device over an insecure link.

The information stored on the smart card controller chip will act as the hub (node, junction, intersection, nexus) for processing. All necessary information is located on the smart card controller chip such as patient's credit card information (for patient's co-pay portion) and insurance policy information to be collected at one location (whether collected from the smart card controller chip at point-of-care or from the Processor's system) so that the payment allocation determination can be made at that location.

Although the instant invention has been described in the context of healthcare (medical or dental), it is understood that the systems, methods and apparatus of this present invention can be applied to numerous applications outside the healthcare industry.

The many specificities described above should not be construed as limitations on the scope of the invention. The above description exemplifies one embodiment thereof and accordingly, the scope of the invention should not be determined only by the embodiment illustrated, but by the appended claims and their legal equivalents as well.

What is claimed is:

1. An electronic healthcare delivery system comprising:
a NFC controller chip;
a smart card controller chip containing multiple applications/layers of information;
a wireless peer-to-peer communication protocol;
a biometric sensor and scanner, said sensor and scanner embedded on the surface and embedded in the surface of the smart card microcontroller, respectively;
a automatic, transparent and ubiquitous open infrastructure of electronic communication between various devices;
a interoperable, intuitive connectivity;
a NFC-enabled mobile device;
a NFC chip and smart card controller chip connected via S2C interface;
a compatibility between NFC-enabled devices and contactless smart cards; and
a paperless healthcare delivery system.

2. The system according to claim 1, wherein said NFC controller chip exchanges necessary link set-up data to enable communication between electronic devices.

3. The system according to claim 1, wherein said NFC controller chip is a smart card reader.

4. The system according to claim 1, wherein said NFC controller chip can be used for direct data transfer and image transfer.

5. The system according to claim 1, wherein said smart card controller chip containing stored medical information, stored secrets, stored patient identifying information, patient insurance information, third party payment information and patient payment information.

6. The system according to claim 5, wherein stored patient identifying information pertains to an authorized patient.

7. The system according to claim 6, wherein the said authorized patient possesses mobile device.

8. The system according to claim 1, wherein the peer-to-peer communication protocol is inherently secure.

9. The system according to claim 8, wherein the peer-to-peer communication protocol establishes wireless network connections between electronics devices and network appliances operating at 13.56 MHz frequency.

10. The system according to claim 1, wherein said biometric sensor and scanner is used for patient identification verification at point-of-care via mobile biometric authentication.

11. The system according to claim 1, wherein the automatic, transparent and ubiquitous open infrastructure of electronic communication enables the simple transfer of information—from patient data to electronic transactions—and allows patients and healthcare providers to interact with their electronic healthcare environment without needing to navigate complicated menus or perform complex set-up procedures.

12. The system according to claim 1, wherein the interoperable, intuitive connectivity effectuates a simple, convenient and paperless experience for the patient and healthcare provider, standardizing the delivery of healthcare at the point-of-care.

13. The system according to claim 1, wherein the NFC-enabled mobile device acts as an initiator and/or target to exchange information to and from NFC-compliant electronic devices.

14. The system according to claim 13, comprising mobile phone, PDA, PC, desktop modem, interactive TV and the like enabled with NFC technology.

15. The system according to claim 1, wherein the said NFC chip connected to smart card controller chip via S2C interface makes NFC transactions bank-application secure for any financial transaction/payment.

16. The system according to claim 1, wherein the compatibility between said NFC-compliant devices and contactless smart cards enable said NFC-enabled devices to work with smart cards and smart card readers.

17. The system according to claim 16, wherein the said contactless smart cards of FeliCA and Mifare protocols are compatible with said peer-to-peer communication protocol.

18. The system according to claim 17, wherein the said protocols conform in a seamless manner.

19. The system according to claim 17, wherein smart cards can be viewed with said NFC-enabled device.

20. The system according to claim 17, wherein said NFC-enabled device can be used instead of said smart card.

21. The system according to claim 1, wherein the said smart card controller chip contains one or more previously-stored secrets of an authorized end user of the mobile device and which has a biometric sensor and biometric scanner embedded on and in the surface of the smart card microcontroller, respectively.

22. The said biometric sensor and biometric scanner according to claim 10, can comprise five different types:
a fingerprint sensor and scanner,
a palm print sensor and scanner;
a voice print sensor and scanner;
a retina scanner; and
a skin chemistry sensor and scanner.

23. The smart card controller chip according to claim 21, wherein the previously-stored secrets can comprise five different types:
a fingerprint of the authorized end user;
a palm print of the authorized end user;
a voice print of the authorized end user;
a retina scan of the authorized end user; and
a skin chemistry of the authorized end user.

24. A method for sharing information at point-of-care between NFC-enabled devices concerning an authorized end user comprising the steps of:
authenticating end user via mobile biometrics;
providing a mobile device associated with an authorized end user, wherein the mobile device provides a reading to an NFC-enabled device;
providing smart card reader;
exchanging link set-up data for communication between wireless devices' interfaces;
providing direct data transfer and image transfer;
obtaining applications/layers of information;
processing of said applications/layers of information to determine patient information, patient insurance information, third pary payment information and patient payment information along with primary payment amount and primary payment source determination and the determination of a secondary payment amount from at least one source of secondary payment to satisfy transaction total; and
establishing said transaction total.

25. The method according to claim 24, wherein said mobile biometrics comprises an instruction for said authenticating user identity.

26. The method according to claim 25, wherein said instruction comprises the steps of:
operating a NFC-enabled device;
operating a security component which provides security functions, such that the security component can vouch for authenticity of components with which it is securely operably connected;
said smart card controller chip containing stored secrets and stored identifying information pertaining to an authorized end user of said NFC-enabled device;
accessing the stored secrets and stored identifying information from said smart card controller chip;
detecting and responding to fingerprint swipe of the said authorized end user at said NFC-enabled device scanner; and
operably secure connecting the smart card reader, the security component and the biometric sensor.

27. The method according to claim 26, wherein said stored identifying information comprises stored biometric information of the authorized end user and further comprising the step of comparing biometric information obtained with the step of comparing biometric information procured with the biometric sensor from an end user, to the stored biometric information of the authorized end user.

28. The method according to claim 26, wherein selected ones of said operably secure connecting are made using the bus of the security component.

29. The method according to claim 28, wherein said security component is said smart card microcontroller comprising:
a CPU;
a memory;
a key storage;
a I/O bus.

30. The method according to claim 26, wherein said operably secure connecting of selected ones are made using wireless connection between the security component and respective ones of the components.

31. The method according to claim 27, wherein said stored secrets comprise encrypting or cryptographically-related public key and private key using public key cryptography, and further comprising the step of digitally signing information presented to the smart card microcontroller with encryption or private key if said step of comparing succeeds and if the biometric sensor, smart card reader, and the security component remain operably secure connected.

32. The method according to claim 27, wherein said step of comparing is performed by said smart card controller chip.

33. The method according to claim 32, further comprising step of securely transferring said biometric information of the authorized patient to the biometric sensor for use of said step of comparing.

34. The method according to claim 33, further comprising interruption step of the secure transfer if said biometric sensor, said smart card reader, and said security component are no longer securely operably connected.

35. The method according to claim 27, wherein said security component performs said step of comparing.

36. The method according to claim 31, further comprising securely operable connecting an application processing component to said security component, and wherein the information presented to the smart card microcontroller is generated via said securely operable connecting application processing component.

37. The method according to claim 27, further comprising the step of concluding that the end user is the authorized user of said NFC-enabled device only if said step of comparing succeeds.

38. The method according to claim 24, wherein said exchange between wireless devices of set-up data comprises parameters and secret key for said communication via NFC chip at point-of-care.

39. The method according to claim 24, wherein said exchange between said NFC-enabled devices is initiated when said NFC-enabled devices touch each other at the “hot spot.”

40. The method according to claim 24, wherein said smart card reader is an NFC-enabled device.

41. The method according to claim 24, wherein said direct data transfer and image transfer take place over Bluetooth or Wi-Fi connection that said NFC chip established.

42. The method according to claim 38, wherein said communication occurs after parameters are exchanged and the secret key is established without any human interference effectuated via exchanged parameters.

43. The method according to claim 39, wherein said communication can continue within a range of 30 meters upon separation of said wireless devices' interface.

44. The method according to claim 39, wherein said communication speeds are from 106 kbps, 212 kbps, 424 kbps to 848 kbps.

45. The method according to claim 39, wherein said communication set-up link is completed in 100-200 milliseconds.

46. The method according to claim 24, wherein said applications/layers of information comprises an instruction for said processing step.

47. The method according to claim 46, wherein said instruction comprises the steps of:
determining patient information, patient insurance information and patient payment information;
determination of said primary payment amount; and
determination of said secondary payment amount after said determination of said primary payment amount.

48. The method according to claim 24, wherein said applications/layers of information comprises data.

49. The method according to claim 24, wherein said applications/layers of information is stored on a smart card controller chip.

50. The method according to claim 24, wherein said processing step is performed at the point-of-care.

51. The method according to claim 24, wherein said point-of-care is at the healthcare provider.

52. The method according to claim 24, wherein said patient information comprises name, address, phone number, social security number and so forth.

53. The method according to claim 47, wherein said primary payment source comprises a health insurance plan.

54. The method according to claim 47, wherein said secondary payment source comprises a patient payment plan and/or a third party payment plan.

55. The method according to claim 48, wherein said patient payment plan is selected from the group consisting of debit card, credit card, electronic check, electronic bank transfers, prepayment, loyalty and gifts.

56. The method according to claim 48, wherein said third party payment plan is selected from the group consisting of government assistance, private credit and insurance settlement.

57. The method according to claim 48, wherein said patient insurance information and patient payment information comprises an instruction of said processing step, said instruction comprising the steps of:
primary payment amount determination from said health insurance plan;
at least a portion of said secondary payment amount determination from said third party payment plan after said determination of said primary payment amount; and
the remainder of said secondary payment amount determination from said patient payment plan.

58. The method according to claim 24, wherein said processing step further comprises the steps of:
prior to completion of the transaction blocking funds from said payment sources; and
upon completion of the transaction claiming payment of said funds.

59. A method of combining total payment for healthcare treatment from multi-independent payment sources into a single payment medium for the treatment, the method comprising the steps of:
healthcare provider treatment cost determination at point-of-care;
patient insurance information and patient payment information procurement at healthcare provider point-of-care;
patient insurance information and patient payment information processing to determine a primary payment amount from an insurance plan and determine a secondary payment amount from at least one secondary payment source to satisfy said treatment cost.

60. The method according to claim 59, wherein said secondary payment source comprises a third party payment source and/or a patient payment source.

61. The method according to claim 59, wherein said healthcare provider is a doctor.

62. The method according to claim 59, wherein said patient insurance information and patient payment information comprises insurance plan contact information and secondary payment source contact information, and wherein said processing step further comprises the steps of:
insurance company contact with said contact information to determine said primary payment amount and an insurance co-payment amount;
funds blocking at said insurance company for said primary payment amount;
said at least one secondary payment source contact with said contact information to determine said secondary payment amount to cover at least a portion of said co-payment amount; and
funds blocking at said at least one secondary payment source for said secondary payment amount.

63. The method according to claim 62, further comprising the steps of;
completing the healthcare provider treatment;
claiming payment of said blocked funds at said insurance company and at said secondary payment source.

64. A method of providing payment for a healthcare treatment comprising the steps for:
treatment cost determination;
analysis of primary payment amount to be provided by an insurance policy for the treatment and a co-payment amount; and
assigning for payment the co-payment amount to a consumer credit medium.

65. The method according to claim 64, wherein said consumer credit medium comprises a patient payment source and/or a third party payment source.

66. A method of providing payment for transaction comprising the steps for:
a treatment cost determination;
analysis of a primary payment amount to be provided by a primary payment source for the transaction and a remainder; and
assigning for payment the remainder amount to a consumer credit medium.

67. The method according to claim 66, wherein said consumer credit medium comprises a patient payment source and/or a third party payment source.

68. A method for end user biometric processing comprising:
a procurement of said NFC-enabled device;
a selection process of said sensors at said point-of-care;
a collection of biometric samples of said biometric sensors; and
a back-end that collects and processes data from said biometric samples.

69. The method according to claim 68, wherein said back-end sends a confirmation text or Short Message Service (SMS) to said point-of-care upon processing completion.

70. A method of payment comprising the steps of:
establishing a treatment cost total at point-ofcare, procuring at point-of-care patient's insurance information and patient's payment information; and
processing of said patient insurance information and patient payment information to determine a primary payment amount from a primary payment source and a secondary payment amount from at least one secondary payment source to satisfy said treatment cost.

71. A method of data exchange to update said applications/layers of information for next point-ofcare healthcare provider visit, comprising:
patient information;
patient insurance information;
patient payment information;
third party payment information;
Electronic Medical Record (EMR);
e-prescription;
lab tests;
MRI images and the like; and
medications.

72. The method according to claim 71, wherein said applications/layers of information is updated comprising the steps of:
authenticating end user via mobile biometrics;
providing a mobile device associated with an authorized end user, wherein the mobile device provides a reading to an NFC-enabled device;
providing smart card reader;
exchanging link set-up data for communication between wireless devices' interfaces;
providing direct data transfer and image transfer;
obtaining applications/layers of information;
processing of said applications/layers of information to determine patient information, patient insurance information, third pary payment information and patient payment information along with primary payment amount and primary payment source determination and the determination of a secondary payment amount from at least one source of secondary payment to satisfy transaction total; and
establishing said transaction total.
